(19) United States
(12) Patent Application Publication
(10) Pub. No.: US 2025/0073975 A1
(43) Pub. Date: Mar. 6, 2025

(54) HEAT-SHRINKABLE FILM AND PROCESS FOR PREPARING THE SAME

(71) Applicant: SK microworks Co., Ltd., Gyeonggi-do (KR)

(72) Inventors: Joo Ho YANG, Gyeonggi-do (KR); Il Ho NOH, Gyeonggi-do (KR); Yong Deuk KIM, Gyeonggi-do (KR)

(21) Appl. No.: 18/777,477

(22) Filed: Jul. 18, 2024

(30) Foreign Application Priority Data
Aug. 29, 2023 (KR) 10-2023-0113994

(51) Int. Cl. B29C 48/00; B29C 48/08; B29C 48/91; B29K 67/00; B29K 105/00; B29K 105/26; B29L 7/00

(52) U.S. Cl. CPC B29C 48/022; B29C 48/0018; B29C 48/08; B29C 48/91; B29K 2067/006; B29K 2067/04; B29K 2105/0085; B29K 2105/0088; B29K 2105/26; B29K 2995/0049; B29K 2995/0096; B29L 2007/008

(57) ABSTRACT

The embodiments relate to a heat-shrinkable film and a process for preparing the same. The heat-shrinkable film comprises a mixed resin, wherein the mixed resin comprises a copolymerized polyester-based resin in which a diol and a dicarboxylic acid are copolymerized; and a polybutylene terephthalate-based resin, and, when a specimen of the heat-shrinkable film having a width of 15 mm, a length of 110 mm, and a thickness of 45 μm is immersed in hot water at 70° C. for 60 seconds to measure shrinkage stress, the development time of the initial shrinkage stress is 20 seconds or shorter. The heat-shrinkable film according to the embodiment comprises a mixed resin having a specific composition, wherein the development time of the initial shrinkage stress is controlled.

### CROSS-REFERENCE TO RELATED APPLICATIONS

This application claims priority under 35 U.S.C. § 119 to Korean Patent Application No. 10-2023-0113994 filed on Aug. 29, 2023, in the Korean Intellectual Property Office. The entire disclosure of each of the foregoing applications is incorporated herein by reference in its entirety.

### TECHNICAL FIELD

Embodiments relate to a heat-shrinkable film and a process for preparing the same.

### BACKGROUND ART

In recent years, as beverage and food containers have been manufactured in various forms, and full-surface packaging has been adopted to attract consumer attention, heat-shrinkable labels and packaging materials are attracting attention.

A heat-shrinkable label or packaging material takes advantage of the feature of a polymer film that tends to shrink to a shape before stretching thereof at a certain temperature or higher once it has been oriented by stretching thereof. In a conventional process of heat shrinkage labeling or packaging, a polymer film (heat-shrinkable film) is printed in a desired design, cut, rolled up, bonded at both ends with an adhesive solvent, loosely wrapped around a container, and then shrunk as heat is applied thereto.

Since a conventional polyester film has a fast shrinkage speed and a high shrinkage stress, there may be defects caused by non-uniform shrinkage or distortions of a plastic container.

In addition, polyester films are prepared by mixing a soft component into a polyester resin to lower crystallinity, and research is focused on achieving thermal properties such as shrinkage rate and shrinkage stress with respect to temperature, and physical properties such as chemical resistance suitable for a seaming process. However, once-used polyester films are discarded without consideration for reuse and recycling, making environmental problems very serious.

Accordingly, there is a need to develop a technology that can achieve excellent thermal (shrinkage) properties and increase recyclability at the same time.

### DISCLOSURE OF INVENTION

### Technical Problem

The embodiments have been devised to solve the problems of the prior art described above.

The technical problems to be solved according to the embodiments is to provide a heat-shrinkable film that is excellent in thermal properties and recyclability, can achieve uniform shrinkage, and can reduce the amount of heat required for shrinkage, thereby effectively saving energy, and a process for preparing the same.

### Solution to Problem

An embodiment provides a heat-shrinkable film that comprises a mixed resin, wherein the mixed resin comprises a copolymerized polyester-based resin in which a diol and a dicarboxylic acid are copolymerized; and a polybutylene terephthalate-based resin, and, when a specimen of the heat-shrinkable film having a width of 15 mm, a length of 110 mm, and a thickness of 45 μm is immersed in hot water at 70° C. for 60 seconds to measure shrinkage stress, the development time of the initial shrinkage stress is 20 seconds or shorter.

Another embodiment provides a process for preparing the heat-shrinkable film that comprises preparing a copolymerized polyester-based resin in which a diol and a dicarboxylic acid are copolymerized; mixing the copolymerized polyester-based resin and a polybutylene terephthalate-based resin to prepare a mixed resin; extruding the mixed resin to prepare an unstretched sheet; and stretching and heat-setting the unstretched sheet to prepare a heat-shrinkable film.

### Advantageous Effects of Invention

The heat-shrinkable film according to the embodiment comprises a mixed resin having a specific composition, wherein the development time of the initial shrinkage stress is controlled. As a result, it is possible to achieve excellent recyclability and uniform shrinkage at the same time and to achieve a rapid shrinkage initiation time, thereby reducing the amount of heat required for shrinkage in the process, resulting in high energy efficiency.

Accordingly, the heat-shrinkable film according to the embodiment can be advantageously applied as a heat-shrinkable label or packaging material to containers of various products including beverages and food.

### BRIEF DESCRIPTION OF DRAWINGS

FIG. 1 shows a heat-shrinkable film (label) applied to a container before (a) and after (b) heat shrinkage thereof.

FIG. 2 shows a method for evaluating the development time of shrinkage stress and shrinkage stress in a heat-shrinkable film according to an embodiment.

FIG. 3 shows a method of measuring the clumping of a polyethylene terephthalate container provided with a heat-shrinkable film according to an embodiment.

FIG. 4 shows a method of measuring the heat shrinkage rate of a heat-shrinkable film according to an embodiment.

FIG. 5 shows a method of measuring the thickness deviation (R) of a heat-shrinkable film according to an embodiment.

FIG. 6 schematically depicts a process for preparing a heat-shrinkable film according to an embodiment.

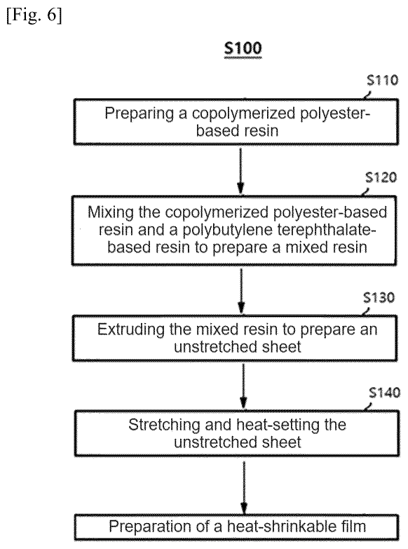

### BEST MODE FOR CARRYING OUT THE INVENTION

In the following description of the embodiments, in the case where an element is mentioned to be formed “on” or “under” another element, it means not only that one element is directly formed “on” or “under” another element, but also that one element is indirectly formed on or under another element with other element(s) interposed between them.

For the sake of description, the sizes of individual elements in the appended drawings may be exaggeratedly depicted, and they may differ from the actual sizes.

Throughout the present specification, when a part is referred to as “comprising” an element, it is understood that other elements may be comprised, rather than other elements are excluded, unless specifically stated otherwise.

All numbers expressing the physical properties, dimensions, and the like of elements used herein are to be understood as being modified by the term “about” unless otherwise indicated.

In the present specification, a singular expression is interpreted to cover a singular or plural number that is interpreted in context unless otherwise specified.

Throughout the present specification, the terms first, second, and the like are used to describe various components. But the components should not be limited by the terms.

In general, a heat-shrinkable film is a film that can be shrunk when applied by heat to thereby tightly pack an article. It has good shrinkage or seaming properties, making it easy to be applied to a labeling process for wrapping at least a portion of a container; thus, it can be used as a heat-shrinkable label.

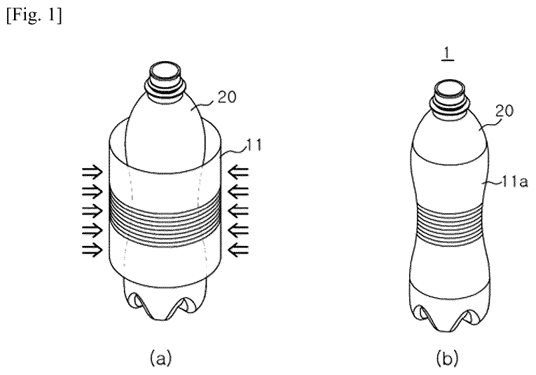

FIG. 1 shows a heat-shrinkable film (label) applied to a container before (a) and after (b) heat shrinkage thereof. Specifically, referring to FIG. 1(a), a heat-shrinkable film is printed with a desired design and rolled, and both ends are bonded with an adhesive solvent to prepare a label (11) in the form of a sleeve, which is loosely wrapped around a container (20) and heated. As a result, as shown in FIG. 1(b), a product in which the heat-shrunk label (11a) tightly adheres along the curve of the container (20) is obtained.

Such a heat-shrinkable film may be rapidly shrunk at a specific temperature, resulting in an uneven appearance or wrinkles, when the temperature is raised in a heat shrinkage process. In particular, if the shrinkage stress is high and the shrinkage initiation time is late, it may cause uneven shrinkage, which is likely to cause poor shrinkage or distortion. Thus, it is very important to control the shrinkage initiation time while maintaining good shrinkage properties.

As a result of in-depth research based on numerous experiments conducted by the present inventors, it has been discovered to complete the present invention that, as a specific type of mixed resin is adopted, the glass transition temperature (Tg) of the mixed resin is lowered, whereby the shrinkage initiation time can be adjusted to be fast, as compared with the conventional heat-shrinkable films, while maintaining shrinkage properties and/or seaming properties; and that, in particular, as the development time of the initial shrinkage stress is adjusted to a specific range, the energy used in hot air or steam required in a labeling process can be effectively reduced by reducing the amount of heat required for shrinkage in the process, and excellent recyclability and uniform shrinkage can be achieved at the same time.

Accordingly, the embodiments have a technical significance in that it is possible to simultaneously improve environmental friendliness characteristics such as energy efficiency and recyclability, and the quality of the film, such as appropriate shrinkage rate and shrinkage stress with respect to temperature, low thickness deviation during film formation, and uniform shrinkage.

Hereinafter, the embodiments will be described in detail as follows.

### Heat-Shrinkable Film

The heat-shrinkable film according to an embodiment comprises a mixed resin, wherein the mixed resin comprises a copolymerized polyester-based resin in which a diol and a dicarboxylic acid are copolymerized; and a polybutylene terephthalate-based resin, and, when a specimen of the heat-shrinkable film having a width of 15 mm, a length of 110 mm, and a thickness of 45 μm is immersed in hot water at 70° C. for 60 seconds to measure shrinkage stress, the development time of the initial shrinkage stress is 20 seconds or shorter.

In the present specification, the term “shrinkage stress” refers to the stress generated when a heat-shrinkable film shrinks due to temperature changes or the like. In addition, in the present specification, the term “initial shrinkage stress” refers to the point at which the shrinkage stress of a heat-shrinkable film initially appears (e.g., the initial point at which the shrinkage stress exceeds 0) when the shrinkage stress of the heat-shrinkable film is measured. In addition, in the present specification, the term “maximum shrinkage stress” refers to the point where the shrinkage stress of a heat-shrinkable film is maximum when the shrinkage stress of the heat-shrinkable film is measured.

Meanwhile, in the present specification, the development time of the initial shrinkage stress refers to the time when the stress generated as a heat-shrinkable film shrinks initially begins to appear (for example, the initial time at which the shrinkage stress exceeds 0). In addition, in the present specification, the development time of the maximum shrinkage stress refers to the time at which the maximum shrinkage stress is reached.

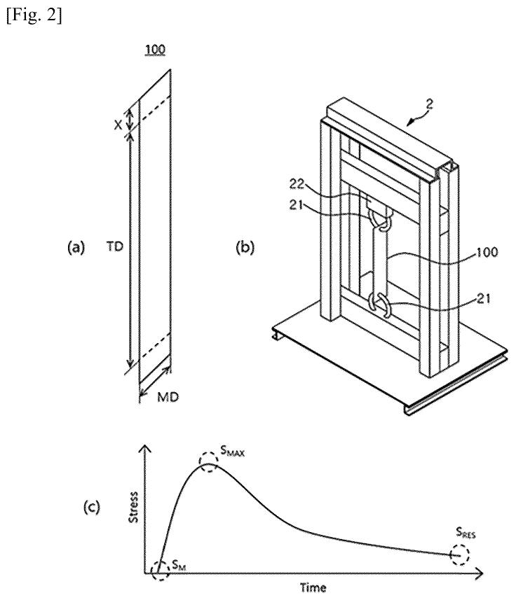

FIG. 2 shows a method for evaluating the development time of shrinkage stress and shrinkage stress in a heat-shrinkable film according to an embodiment.

Referring to FIGS. 2(a) to 2(c), the heat-shrinkable film (100) according to an embodiment is cut to 120 mm in the transverse direction (TD) to be measured and 15 mm in the longitudinal direction (MD) perpendicular thereto (see FIG. 2(a)). The heat-shrinkable film specimen (100) with a width of 15 mm, a length of 110 mm, and a thickness of 45 μm, excluding 5 mm at each end (X) in the transverse direction (TD), is mounted on a stress tester (2), such as a shrinkage stress meter, such that both ends (X) of the film (excluded from measurement) may be fixed to both jigs (21) spaced apart by 100 mm (space between the jigs (21) is about 100 mm) (see FIG. 2(b)). That is, the length of the heat-shrinkable film specimen (100) is a value excluding both ends (X) of 5 mm each in the transverse direction (TD), and the width thereof is a value cut in the longitudinal direction (MD).

The heat-shrinkable film specimen (100) as mounted is fixed in the transverse direction (TD), which is the main shrinkage direction, and immersed in hot water at 70° C. for 60 seconds to measure shrinkage stress using a load cell (22). The initial shrinkage stress (S_{M}), maximum shrinkage stress (S_{MAX}), and residual shrinkage stress (S_{RES}) after shrinkage may be confirmed in a graph of stress (N) with respect to time (time, s) measured during the shrinkage procedure. In such an event, the graph of stress with respect to time may be obtained by removing noise generated when the heat-shrinkable film specimen is introduced in the procedure of measuring the shrinkage stress. In addition, the load cell (22) used in the procedure of measuring the shrinkage stress may have a capacity of 10 kg.

The initial shrinkage stress (S_{M}) may refer to the stress at the lowest point (stress that initially exceeds 0) in the graph (curve) of stress with respect to time. The maximum shrinkage stress (S_{MAX}) may refer to the stress at the highest point in the graph (curve) of stress with respect to time. The residual shrinkage stress (S_{RES}) after shrinkage may refer to the stress at the end point of the shrinkage time.

According to an embodiment, when the heat-shrinkable film specimen having a width of 15 mm, a length of 110 mm, and a thickness of 45 μm is immersed in hot water at 70° C. for 60 seconds to measure shrinkage stress, the development time of the initial shrinkage stress of the heat-shrinkable film (heat-shrinkable film specimen) may be 20 seconds or shorter. Specifically, the development time of the initial shrinkage stress may be 17 seconds or shorter, 14 seconds or shorter, 13 seconds or shorter, 11 seconds or shorter, 10 seconds or shorter, 9 seconds or shorter, 8 seconds or shorter, 7 seconds or shorter, 6 seconds or shorter, 5 seconds or shorter, 4 seconds or shorter, 3 seconds or shorter, or 2 seconds or shorter. For example, the development time of the initial shrinkage stress may be 1 second to 20 seconds, 1 second to 16 seconds, 1 second to 15 seconds, 2 seconds to 12 seconds, 2 seconds to 10 seconds, 2 seconds to 9 seconds, 2 seconds to 5 seconds, 2.5 seconds to 19 seconds, 2.5 seconds to 18 seconds, 2.6 seconds to 16 seconds, 2.6 seconds to 15 seconds, 2.7 seconds to 10 seconds, 2.7 seconds to 8 seconds, 2.8 seconds to 7 seconds, or 2.8 seconds to 5 seconds.

In addition, when the heat-shrinkable film specimen having a width of 15 mm, a length of 110 mm, and a thickness of 45 μm is immersed in hot water at 70° C. for 60 seconds to measure shrinkage stress, the development time of the maximum shrinkage stress of the heat-shrinkable film (heat-shrinkable film specimen) may be 60 seconds or shorter. Specifically, the development time of the maximum shrinkage stress may be 55 seconds or shorter, 50 seconds or shorter, 45 seconds or shorter, 40 seconds or shorter, 35 seconds or shorter, 30 seconds or shorter, 25 seconds or shorter, 20 seconds or shorter, 15 seconds or shorter, 10 seconds or shorter, or 5 seconds or shorter. For example, the development time of the maximum shrinkage stress may be 1 second to 60 seconds, 1 second to 50 seconds, 1 second to 40 seconds, 2 seconds to 35 seconds, 2 seconds to 30 seconds, 2 seconds to 28 seconds, 2 seconds to 25 seconds, 2.8 seconds to 25 seconds, 2.8 seconds to 20 seconds, 2.8 seconds to 15 seconds, 3 seconds to 12 seconds, 3.2 seconds to 10 seconds, 3.5 seconds to 8 seconds, 4 seconds to 6 seconds, or 4.5 seconds to 5 seconds.

In addition, when the heat-shrinkable film specimen having a width of 15 mm, a length of 110 mm, and a thickness of 45 μm is immersed in hot water at 70° C. for 60 seconds to measure shrinkage stress, the time for the shrinkage stress of the heat-shrinkable film (heat-shrinkable film specimen) to reach 0.5 N may be 20 seconds or shorter. Specifically, the time for the shrinkage stress to reach 0.5 N may be 18.5 seconds or shorter, 18 seconds or shorter, 17 seconds or shorter, 16 seconds or shorter, 15 seconds or shorter, 13 seconds or shorter, 12 seconds or shorter, 10 seconds or shorter, 9 seconds or shorter, 8 seconds or shorter, 6 seconds or shorter, 5 seconds or shorter, 3.5 seconds or shorter, or 2.5 seconds or shorter. For example, the time for the shrinkage stress to reach 0.5 N may be 1 second to 19 seconds, 1 second to 18.5 seconds, 1 second to 17 seconds, 2 seconds to 14 seconds, 2 seconds to 13 seconds, 2 seconds to 10 seconds, 2 seconds to 8 seconds, 2.3 seconds to 20 seconds, 2.3 seconds to 18 seconds, 2.5 seconds to 15.5 seconds, 2.5 seconds to 13.5 seconds, 2.6 seconds to 12 seconds, 2.6 seconds to 10 seconds, 2.7 seconds to 8 seconds, or 2.8 seconds to 4.5 seconds.

When the development time of the initial shrinkage stress and that of the maximum shrinkage stress of the heat-shrinkable film are each controlled to satisfy the above range, the shrinkage initiation time is short, whereby shrinkage can be easily completed with a small amount of heat; thus, it is possible to save energy during the process and to achieve uniform shrinkage and excellent recyclability at the same time.

The initial shrinkage stress and maximum shrinkage stress of the heat-shrinkable film may be controlled in various ways. For example, the initial shrinkage stress and maximum shrinkage stress may be controlled by adjusting the type of mixed resin contained in the heat-shrinkable film, its content, and the physical properties and composition of each resin, or adjusting process conditions of the heat-shrinkable film, such as extrusion temperature, casting temperature, preheating temperature during stretching, stretching ratio in each direction, stretching temperature, and stretching speed, or adjusting thermal treatment temperature and relaxation rate while carrying out thermal treatment and relaxation after stretching.

In addition, the shrinkage stress of the heat-shrinkable film may be adjusted to a specific range.

According to an embodiment, when the heat-shrinkable film specimen having a width of 15 mm, a length of 110 mm, and a thickness of 45 μm is immersed in hot water at 70° C. for 60 seconds to measure shrinkage stress, the maximum shrinkage stress (S_{MAX}) of the heat-shrinkable film may be 2.5 N to 10.0 N. Specifically, the maximum shrinkage stress (S_{MAX}) of the heat-shrinkable film may be 2.5 N to 9.0 N, 2.5 N to 8.0 N, 2.5 N to 7.0 N, 2.5 N to 6.8 N, 2.8 N to 9.0 N, 2.8 N to 8.0 N, 2.8 N to 7.0 N, 2.8 N to 6.8 N, 3.0 N to 9.0 N, 3.0 N to 8.0 N, 3.0 N to 7.0 N, 3.0 N to 6.8 N, 3.2 N to 9.0 N, 3.2 N to 8.0 N, 3.2 N to 7.0 N, 3.2 N to 6.8 N, 3.3 N to 9.0 N, 3.3 N to 8.0 N, 3.3 N to 7.0 N, 3.3 N to 6.8 N, 3.5 N to 9.0 N, 3.5 N to 8.0 N, 3.5 N to 7.0 N, 3.5 N to 6.8 N, 3.5 N to 6.0 N, or 4.0 N to 6.0 N.

When the maximum shrinkage stress (S_{MAX}) of the heat-shrinkable film satisfies the above range, it is possible to minimize defects caused by non-uniform shrinkage or distortions of a plastic container, and it shrinks uniformly during a heat shrinkage process, whereby it can tightly adhere to the container without appearance defects such as distortion or curling after shrinkage, providing a uniform appearance. If the maximum shrinkage stress (S_{MAX}) of the heat-shrinkable film is outside the above range, there may be defects caused by non-uniform shrinkage, distortions of a plastic container, or wrinkles, resulting in appearance defects.

In addition, according to an embodiment, when the heat-shrinkable film specimen having a width of 15 mm, a length of 110 mm, and a thickness of 45 μm is immersed in hot water at 70° C. for 60 seconds to measure shrinkage stress, the residual shrinkage stress (S_{RES}) of the heat-shrinkable film (heat-shrinkable film specimen) may be 10 N or less, 8 N or less, 6 N or less, 5 N or less, 4 N or less, or 3 N or less, for example, 0.5 N to 5 N, 1 N to 5 N, 2 N to 5 N, or 2 N to 4 N. When the residual shrinkage stress (S_{RES}) satisfies the above range, it can tightly adhere to the container without appearance defects such as distortion or curling after shrinkage when used as a label.

As a specific example, when the heat-shrinkable film is immersed in hot water at 70° C. for 60 seconds to measure shrinkage stress, the maximum shrinkage stress may be 2.5 N to 10.0 N, and the residual shrinkage stress (S_{RES}) may be 1 N to 5 N.

The heat-shrinkable film according to an embodiment has a short development time of the initial shrinkage stress and the maximum shrinkage stress; thus, the shrinkage speed is fast. In particular, the shrinkage stress, specifically the maximum shrinkage stress (S_{MAX}) and the residual shrinkage stress (S_{RES}), are reduced to the optimal ranges. In such a case, shrinkability is good, process speed is faster, and the quality, yield, and productivity of a final product can be enhanced at the same time.

Meanwhile, in order to achieve the desired crystallinity and thickness deviation of the heat-shrinkable film, it is important to control the crystallization temperature (Tc), glass transition temperature (Tg), and melting temperature (Tm) to specific ranges.

The crystallization temperature (Tc), glass transition temperature (Tg), and melting temperature (Tm) may be measured by analyzing the heat-shrinkable film using differential scanning calorimetry (DSC). Specifically, the heat-shrinkable film is placed in a differential scanning calorimeter (DSC) and scanned at a temperature elevation rate of 10° C./minute using a differential scanning calorimeter (DSC) mode. For example, the scan may comprise (1) first heating measurement over the temperature range of 25° C. to 300° C. at a scan rate of 10° C./minute; (2) maintaining isothermal at 300° C. for 10 minutes; (3) first cooling measurement over the temperature range of 300° C. to 25° C. at a scan rate of 10° C./minute; (4) maintaining isothermal at 25° C. for 10 minutes; and (5) second heating measurement over the temperature range of 25° C. to 300° C. at a scan rate of 10° C./minute. A heat flow curve may be obtained through the above scanning procedure. In the heat flow curve, the first exothermic temperature in the first heating measurement (step (1)) may refer to the crystallization temperature (Tc), and the endothermic temperature measured after the crystallization temperature (Tc) may refer to the melting temperature (Tm). In addition, the endothermic temperature measured during the second heating measurement (step (5)) after the first cooling measurement (step (3)) may refer to the glass transition temperature (Tg).

In general, when a polybutylene terephthalate resin is used, crystallization takes place quickly, which may adversely affect a heat shrinkage process and a seaming process, and thickness deviation may also increase. Thus, the above problem can be solved by controlling the crystallization temperature (Tc), glass transition temperature (Tg), and melting temperature (Tm) to specific ranges.

According to an embodiment, the difference (Tc−Tg) between the crystallization temperature (Tc) and the glass transition temperature (Tg) of the heat-shrinkable film may be 10° C. or more. Specifically, the difference (Tc−Tg) between the crystallization temperature (Tc) and the glass transition temperature (Tg) may be 8° C. or more, 9° C. or more, greater than 9° C., 10° C. or more, for example, 10° C. to 100° C., 10° C. to 90° C., 10° C. to 80° C., 10° C. to 70° C., 10° C. to 68° C., 20° C. to 100° C., 20° C. to 90° C., 20° C. to 80° C., 20° C. to 70° C., 20° C. to 68° C., 24° C. to 100° C., 24° C. to 90° C., 24° C. to 80° C., 24° C. to 70° C., 24° C. to 68° C., 24° C. to 65° C., 24° C. to 50° C., 24° C. to 44° C., or 24° C. to 35° C. When the difference (Tc−Tg) between the crystallization temperature (Tc) and the glass transition temperature (Tg) satisfies the above range, the thickness deviation of the heat-shrinkable film can be minimized, and excellent recyclability and uniform shrinkage can be achieved at the same time.

In addition, the crystallization temperature (Tc) of the heat-shrinkable film may specifically be 50° C. to 200° C., 50° C. to 180° C., 50° C. to 150° C., 50° C. to 140° C., 50° C. to 139° C., 50° C. to 120° C., 50° C. to 115° C., 72° C. to 200° C., 72° C. to 180° C., 72° C. to 150° C., 72° C. to 140° C., 72° C. to 139° C., 72° C. to 120° C., 72° C. to 115° C., 80° C. to 140° C., 80° C. to 139° C., 80° C. to 120° C., 80° C. to 115° C., 90° C. to 140° C., 90° C. to 139° C., 90° C. to 120° C., or 90° C. to 115° C. As the crystallization temperature (Tc) of the heat-shrinkable film is adjusted to the above range, it is possible to effectively control the crystallinity of the heat-shrinkable film, whereby the clumping ratio is very low in the regeneration process of the heat-shrinkable film or a polyethylene terephthalate (PET) container comprising the heat-shrinkable film. Thus, it is possible to prevent environmental pollution while recyclability is enhanced.

The glass transition temperature (Tg) of the heat-shrinkable film may specifically be 100° C. or lower, 90° C. or lower, 80° C. or lower, 75° C. or lower, or 73° C. or lower, for example, 40° C. to 100° C., 40° C. to 90° C., 40° C. to 80° C., 40° C. to 75° C., 40° C. to 73° C., 50° C. to 100° C., 50° C. to 90° C., 50° C. to 80° C., 50° C. to 75° C., 50° C. to 73°° C., 63° C. to 100° C., 63° C. to 90° C., 63° C. to 80° C., 63° C. to 75° C., 63° C. to 73° C., 65° C. to 100° C., 65° C. to 90° C., 65° C. to 80° C., 65° C. to 75° C., or 65° C. to 73° C. As the glass transition temperature (Tg) of the heat-shrinkable film is adjusted to the above range, the desired fast shrinkage initiation time can be achieved, and the thickness deviation can be reduced while exhibiting uniform shrinkage, whereby a heat-shrinkable film with excellent physical properties can be obtained.

In addition, the melting temperature (Tm) of the heat-shrinkable film may specifically be 150° C. or higher, 180° C. or higher, 200° C. or higher, or 202° C. or higher, for example, 150° C. to 300° C., 180° C. to 300° C., 200° C. to 300° C., 200° C. to 280° C., 200° C. to 260° C., 200° C. to 250° C., 200° C. to 240° C., or 200° C. to 235° C.

According to an embodiment, the heat-shrinkable film may have one or more melting temperatures (Tm).

Specifically, the heat-shrinkable film may have one melting temperature (Tm). Alternatively, the heat-shrinkable film may have two or more melting temperatures (Tm). For example, the heat-shrinkable film may have two or more of a first melting temperature (Tm1) and a second melting temperature (Tm2). When the heat-shrinkable film has two or more of a first melting temperature (Tm1) and a second melting temperature (Tm2), the first melting temperature (Tm1) and the second melting temperature (Tm2) may each represent different melting temperatures within the above range.

For example, the first melting temperature (Tm1) of the heat-shrinkable film may be 150° C. to 300° C., 155° C. to 300° C., 160° C. to 300° C., 160° C. to 280° C., 165° C. to 260° C., 165° C. to 250° C., 170° C. to 240° C., 170° C. to 235° C., 175° C. to 230° C., 175° C. to 225° C., 180° C. to 220° C., or 185° C. to 210° C.

In addition, the second melting temperature (Tm2) of the heat-shrinkable film may be 150° C. to 300° C., 180° C. to 300° C., 200° C. to 300° C., 200° C. to 280° C., 200° C. to 260° C., 200° C. to 250° C., 200° C. to 240° C., 200° C. to 235° C., 200° C. to 233° C., 205° C. to 233° C., or 210° C. to 233° C.

Further, when the heat-shrinkable film has the first melting temperature (Tm1) and the second melting temperature (Tm2), the difference between the first melting temperature (Tm1) and the second melting temperature (Tm2) may be 10° C. to 30° C., 10° C. to 25° C., 15° C. to 25° C., or 15° C. to 22° C.

Since the melting temperature (Tm) of the heat-shrinkable film satisfies the above range, it is possible to effectively control its crystallinity, whereby the seaming properties as adhesive strength by a solvent are excellent, while the clumping ratio is very low in the regeneration process of the heat-shrinkable film or a polyethylene terephthalate (PET) container comprising the heat-shrinkable film. Thus, it is possible to prevent environmental pollution while recyclability is enhanced.

According to an embodiment, the heat-shrinkable film may have a clumping ratio (CR) of 10% or less as represented by the following Equation 1:

$$Clumping ratio ( CR , \% ) = \frac{{C}_{195}}{{C}_{25}} \times 100 \qquad [ Equation 1 ]$$

In Equation 1, C₂₅ is the initial weight (g) of mixed flakes obtained by crushing a polyethylene terephthalate (PET) container provided with the heat-shrinkable film at 25° C., and C₁₉₅ is the weight (g) of aggregated flakes that have not been filtered through a 12.5-mm sieve when the mixed flakes obtained by crushing the polyethylene terephthalate (PET) container provided with the heat-shrinkable film are thermally treated at 195° C. for 90 minutes and then filtered.

The clumping ratio may be an indicator of the degree of recyclability. That is, the lower the clumping ratio is, the better the recyclability may be. The higher the clumping ratio is, the lower the recyclability may be. Thus, the embodiments may increase recyclability by lowering the clumping ratio.

Specifically, clumping refers to an aggregate that may be formed in a regeneration process. The size of the aggregates may be, for example, at least two times or three times the size of the flake particles before the thermal treatment. The clumping ratio refers to the fraction of the aggregates based on the total weight of the initially mixed flakes, that is, the flakes before the thermal treatment.

In a regeneration process of a polyethylene terephthalate (PET) container in which the heat-shrinkable film is provided as a label, the flakes obtained by crushing them are passed through a sieve and then subjected to a thermal treatment process. In such an event, aggregates may be formed as the crushed flakes are clumped, which aggregates are called clumping. The aggregates are again filtered through a sieve, and the weight is measured. The weight ratio of the aggregates based on the total weight of the flakes before the thermal treatment is calculated as a clumping ratio. Thus, the higher the value of the clumping ratio is, the lower the recyclability may be.

Since the heat-shrinkable film according to an embodiment is effectively controlled in crystallinity, there are no wrinkles when applied as a label for a polyethylene terephthalate (PET) container or distortions of the polyethylene terephthalate container. In addition, even if the flakes crushed together with a polyethylene terephthalate container upon completion of its use are thermally treated during a regeneration process, the clumping ratio is very low. Thus, it is possible to enhance recyclability, as well as to enhance the quality, yield, and productivity of regenerated polyester chips, for example, produced by recycling.

If flakes are fused to form clumps in a common regeneration process, it may cause various problems. Thus, the U.S. Association of Plastic Recyclers (APR) is preparing a procedure (APR PET-S-08) to evaluate a clumping ratio.

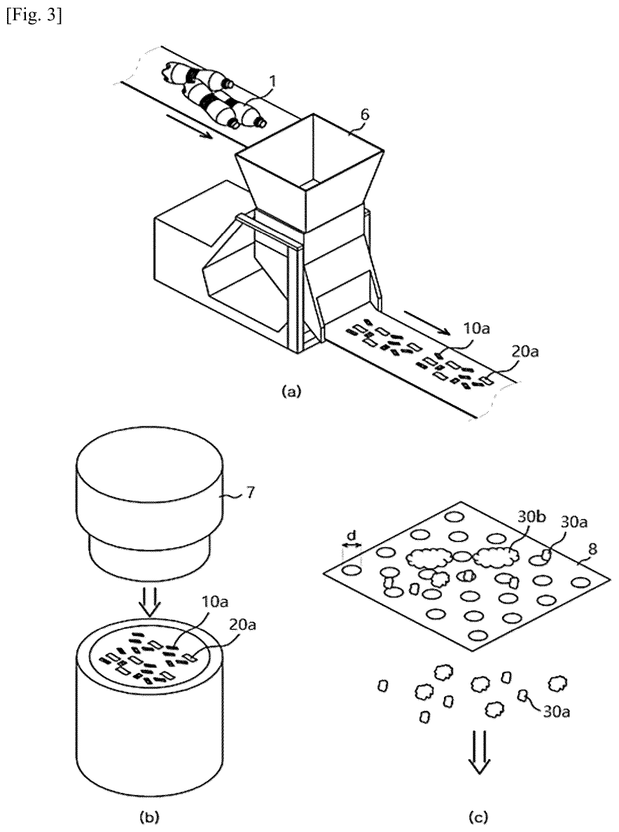

FIG. 3 shows a method of measuring the clumping of a polyethylene terephthalate container provided with a heat-shrinkable film according to an embodiment.

Referring to FIGS. 1 and 3 together, specifically, for measuring the clumping ratio, a product (1) in which a heat-shrinkable film is provided as a label (11a) in a polyethylene terephthalate (PET) container (20) was crushed in a crusher (6) and passed through a sieve (0.374″ sieve, not shown) having an average hole diameter of 9.5 mm to obtain mixed flakes composed of 97 g of first flakes (20a) obtained by crushing the polyethylene terephthalate (PET) container and 3 g of second flakes (label flakes) (10a) obtained by crushing the heat-shrinkable film (see FIG. 1 and FIG. 3(a)).

Thereafter, the mixed flakes are placed on a cylinder with a diameter of 6 cm and a height of 8 cm, a weight (7) of 2.5 kg is placed on top of them to apply a pressure of 8.7 kPa, and then the cylinder with the weight (7) thereon is placed in a convection oven at 195° C. for thermal treatment for 90 minutes, followed by cooling thereof to room temperature (see FIG. 3(b)).

Next, the cooled mixed flakes are sieved using a second sieve (0.492″ sieve) with an average hole diameter (d) of 12.5 mm to obtain flakes (30a) that have passed through the second sieve (8) after thermal treatment and flakes, aggregated flakes (30b), that have not passed through the second sieve (8) (remaining on the second sieve (8)) after thermal treatment (FIG. 3(c)). The weight of the aggregated flakes (30b) may be measured to calculate the clumping ratio (CR) represented by Equation 1 can be calculated.

According to an embodiment, the clumping ratio (CR) may be 10% or lower, 9% or lower, 8% or lower, 7% or lower, 6% or lower, 5% or lower, 4% or lower, 3% or lower, 2% or lower, 1% or lower, less than 1%, 0.9% or lower, 0.8% or lower, 0.7% or lower, 0.6% or lower, or 0.5% or lower. For example, the clumping ratio (CR) may be 0.05% to 10%, 0.05% to 9%, 0.05% to 6%, 0.05% to 5%, 0.05% to 4%, 0.05% to 3%, 0.05% to 2%, 0.05% to 1%, 0.05% to 0.95%, or 0.1% to 0.95%.

Meanwhile, the heat-shrinkable film may have a heat shrinkage rate with respect to temperature controlled to a specific level.

According to an embodiment, the heat-shrinkable film may have a heat shrinkage rate of 45% or more as represented by the following Equation 2:

$$Heat shrinkage rate ( T {S}_{100} , \% ) = \frac{x 1 - x 2}{x 1} \times 100 \qquad [ Equation 2 ]$$

In Equation 2, x1 is the initial length of the heat-shrinkable film specimen measured at 25° C., and x2 is the length of the heat-shrinkable film specimen, after shrinkage, measured after immersion in hot water at 100° C. for 10 seconds.

Specifically, the heat shrinkage rate represented by the above Equation 2 may be 48% or more, 50% or more, 58% or more, 60% or more, or 70% or more, for example, 48% to 90%, 60% to 90%, or 70% to 85%.

In addition, the heat-shrinkable film may have a heat shrinkage rate of 8% or more as represented by the following Equation 2-1:

$$Heat shrinkage rate ( T {S}_{70} , \% ) = \frac{x 1 - x 3}{x 1} \times 100 \qquad [ Equation 2 - 1 ]$$

In Equation 2-1, x1 is the initial length of the heat-shrinkable film specimen measured at 25° C., and x3 is the length of the heat-shrinkable film specimen, after shrinkage, measured after immersion in hot water at 70° C. for 10 seconds.

Specifically, the heat shrinkage rate represented by the above Equation 2-1 may be 10% or more, 15% or more, 18% or more, 19% or more, 20% or more, 30% or more, 40% or more, or 45% or more, for example, 10% to 90%, 19% to 80%, or 20% to 70%.

In addition, the heat-shrinkable film may have a heat shrinkage rate of 20% or more as represented by the following Equation 2-2:

$$Heat shrinkage rate ( T {S}_{80} , \% ) = \frac{x 1 - x 4}{x 1} \times 100 \qquad [ Equation 2 - 2 ]$$

In Equation 2-2, x1 is the initial length of the heat-shrinkable film specimen measured at 25° C., and x4 is the length of the heat-shrinkable film specimen, after shrinkage, measured after immersion in hot water at 80° C. for 10 seconds.

Specifically, the heat shrinkage rate represented by the above Equation 2-2 may be 25% or more, 28% or more, 30% or more, 32% or more, 35% or more, 40% or more, 45% or more, 50% or more, or 51% or more, for example, 25% to 90%, 32% to 90%, or 50% to 85%. In addition, the heat-shrinkable film may have a heat shrinkage rate of 40% or more as represented by the following Equation 2-3:

$$Heat shrinkage rate ( T {S}_{90} , \% ) = \frac{x 1 - x 5}{x 1} \times 100 \qquad [ Equation 2 - 3 ]$$

In Equation 2-3, x1 is the initial length of the heat-shrinkable film specimen measured at 25° C., and x5 is the length of the heat-shrinkable film specimen, after shrinkage, measured after immersion in hot water at 90° C. for 10 seconds.

Specifically, the heat shrinkage rate represented by the above Equation 2-3 may be 45% or more, 48% or more, 50% or more, 53% or more, 55% or more, 60% or more, or 65% or more, for example, 45% to 90%, 53% to 90%, or 60% to 85%.

In the heat-shrinkable film according to an embodiment, the shrinkage rate in the main shrinkage direction with respect to temperature may be adjusted to the specific ranges. In such a case, it is easy to perform a labeling process in which the heat-shrinkable film wraps at least a portion of a container. In particular, when the heat-shrinkable film is used as a label on a polyethylene terephthalate (PET) container, it is possible to minimize wrinkles on the label or distortion of the polyethylene terephthalate (PET) container.

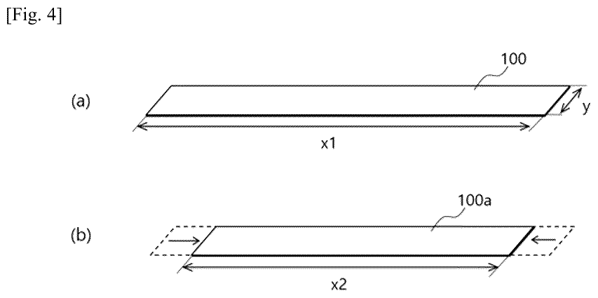

FIG. 4 shows a method of measuring the heat shrinkage rate of a heat-shrinkable film according to an embodiment.

Referring to FIG. 4, the heat-shrinkable film (100) is cut to 300 mm in the main shrinkage direction (transverse direction (TD)) and 15 mm in the direction perpendicular thereto (longitudinal direction (MD)). Here, 300 mm is the first dimension (x1) before shrinkage, and 15 mm is the second dimension (y) (see FIG. 4(a)). Thereafter, the cut heat-shrinkable film (100) is immersed in a heated water bath (at the temperatures described in x2 to x5 of Equation 2 and Equation 2-1 to Equation 2-3) for 10 seconds and then taken out. The first dimension (x2) after shrinkage is measured (see FIG. 4(b)). The heat shrinkage rates represented by Equation 2 and Equation 2-1 to Equation 2-3 may then be calculated. Meanwhile, the heat-shrinkable film may have a thickness deviation (R) of 15 μm or less as represented by the following Equation 3:

$$Thickness deviation ( R , μm ) = TA - TF \qquad [ Equation 3 ]$$

In Equation 3, TA and TF are values calculated using the thicknesses measured with a thickness gauge at intervals of 2 cm in the transverse direction (TD) with the center point in the longitudinal direction (MD) of the heat-shrinkable film specimen having a width of 300 mm and a length of 200 mm as an axis.

TA is the average thickness (μm) of the heat-shrinkable film (heat-shrinkable film specimen), and TF is the thickness (μm) showing the maximum difference from the average thickness among the measured thicknesses.

Specifically, the thickness deviation (R) of the heat-shrinkable film may be 12 μm or less, 10 μm or less, 8 μm or less, 6 μm or less, 5 μm or less, 4 μm or less, 3 μm or less, or 2 μm or less, for example, 0 to 15 μm, 1 to 13 μm, 1 to 10 μm, 1 to 8 μm, 1 to 6 μm, 1 to 5 μm, 1 to 4 μm, 1 to 3 μm, or 1 to 2μ m.

When the thickness deviation (R) of the heat-shrinkable film satisfies the above range, the thickness deviation during film formation is low, showing uniform shrinkage, whereby the quality of the film can be enhanced.

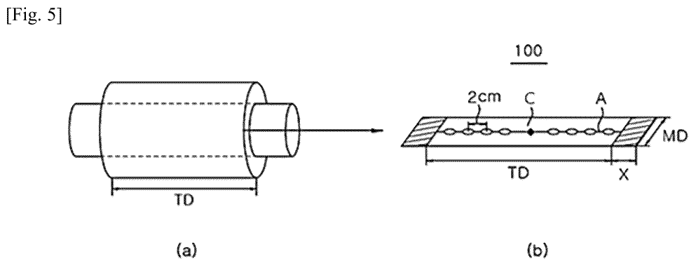

FIG. 5 shows a method of measuring the thickness deviation (R) of a heat-shrinkable film according to an embodiment.

Referring to FIG. 5, for measuring the thickness deviation (R), a roll of the heat-shrinkable film is cut across the entire width of the film in the transverse direction (TD) (the portion of dotted lines in FIG. 5(a)). The thickness of the obtained heat-shrinkable film specimen having a width of 300 mm and a length of 200 mm may be measured using a thickness gauge. When the thickness is measured, the thickness is measured at intervals of 2 cm in the transverse direction (TD) with the center (C) point in the longitudinal direction (MD) of the heat-shrinkable film specimen as an axis. In addition, the average thickness of the heat-shrinkable film and the thickness showing the maximum difference from the average thickness are obtained using the respective thicknesses measured. Then, the thickness deviation (R) represented by the above Equation 3 may be calculated.

The heat-shrinkable film may have a thickness of 10 μm to 100 μm. For example, the thickness of the heat-shrinkable film may be 20 μm to 80 μm or 30 μm to 70 μm. When the thickness of the heat-shrinkable film is within the above range, it may be more advantageous in terms of shrinkage uniformity and printability of the heat-shrinkable film.

Specifically, the stretching may be uniaxial stretching or biaxial stretching. More specifically, the stretching may be uniaxial stretching carried out in the transverse direction (TD), or biaxial stretching carried out in the longitudinal direction (MD) and then in the transverse direction (TD), or biaxial stretching carried out in the transverse direction (TD) and then in the longitudinal direction (MD).

When the stretching is uniaxial stretching, the stretching ratio of the heat-shrinkable film in the main shrinkage direction may be 3.0 times to 6.0 times, 3.5 times to 5.0 times, 3.5 times to 4.5 times, or 3.5 times to 4.2 times.

In addition, when the stretching is biaxial stretching, the stretching may be carried out in the longitudinal direction (MD) at a stretching ratio of 1.1 times to 2 times or 1.1 times to 1.5 times, and then in the transverse direction (TD) at a stretching ratio of 3.5 times to 5 times, 3.5 times to 4.8 times, or 3.8 times to 4.6 times.

The main shrinkage direction of the heat-shrinkable film may be the transverse direction (TD), and a direction perpendicular to the main shrinkage direction may be the longitudinal direction (MD), but they are not particularly limited thereto.

### Composition of the Heat-Shrinkable Film

The heat-shrinkable film according to an embodiment may comprise a mixed resin having specific components.

Specifically, the heat-shrinkable film is a heat-shrinkable film comprising a mixed resin, wherein the mixed resin may comprise a copolymerized polyester-based resin in which a diol and a dicarboxylic acid are copolymerized; and a polybutylene terephthalate-based resin.

In the mixed resin, the mixing weight ratio of the polyester-based resin and the polybutylene terephthalate-based resin may be very important in achieving the desired effect. Thus, according to an embodiment, the mixing weight ratio of the polyester-based resin and the polybutylene terephthalate-based resin may be controlled to a specific range.

Specifically, in the mixed resin, the mixing weight ratio of the polyester-based resin and the polybutylene terephthalate-based resin may be 50:50 to 99.5:0.5, 60:40 to 99.5:0.5, 65:35 to 99.5:0.5, 66:34 to 99.5:0.5, 70:30 to 99.5:0.5, 75:25 to 99.5:0.5, 80:20 to 99.5:0.5, 60:40 to 99:1, 66:34 to 99:1, 70:30 to 99:1, 75:25 to 99:1, 80:20 to 99:1, 60:40 to 97:3, 65:35 to 97:3, 66:34 to 97:3, 70:30 to 97:3, 75:25 to 97:3, 80:20 to 97:3, 60:40 to 95:5, 75:25 to 95:5, 80:20 to 95:5, 85:15 to 95:5, 90:10 to 97:3, 90:10 to 95:5, 92:8 to 97:3, or 94:6 to 97:3.

When the mixing weight ratio of the polyester-based resin and the polybutylene terephthalate-based resin satisfies the above range, it is advantageous for controlling the development time of the initial shrinkage stress and/or maximum shrinkage stress. As a result, it is possible to achieve excellent recyclability and uniform shrinkage at the same time and to achieve a rapid shrinkage initiation time, thereby reducing the amount of heat required for shrinkage in the process, resulting in high energy efficiency. Thus, the quality, yield, and productivity of a final product can be enhanced at the same time.

In addition, the mixed resin may have an intrinsic viscosity of 0.6 dl/g to 1.2 dl/g, 0.7 dl/g to 1.1 dl/g, 0.75 dl/g to 0.95 dl/g, or 0.78 dl/g to 0.9 dl/g, when measured according to ASTM D2857. When the intrinsic viscosity of the mixed resin is within the above range, it may be more advantageous for achieving the desired effect.

Hereinafter, the mixed resin will be described in detail.

### Copolymerized Polyester-Based Resin

According to an embodiment, the mixed resin contained in the heat-shrinkable film comprises a copolymerized polyester resin in which a diol and a dicarboxylic acid are copolymerized.

For example, the copolymerized polyester-based resin may be one in which two or more diols and a dicarboxylic acid are polymerized. Specifically, the copolymerized polyester-based resin may be one in which three or more diols and a dicarboxylic acid are polymerized. More specifically, the copolymerized polyester-based resin may be one in which three diols and a dicarboxylic acid are polymerized.

The diol may comprise an aliphatic diol, an alicyclic diol, an aromatic diol, or a derivative thereof. The aliphatic diol may be, for example, an aliphatic diol having 2 to 10 carbon atoms, and it may have a linear or branched structure.

As a specific example, the aliphatic diol may comprise ethylene glycol, diethylene glycol, neopentyl glycol, 1,3-propanediol, 1,2-octanediol, 1,3-octanediol, 2,3-butanediol, 1,3-butanediol, 1,4-butanediol, 1,5-pentanediol, 2-butyl-2-ethyl-1,3-propanediol, 2,2-diethyl-1,5-pentanediol, 2,4-diethyl-1,5-pentanediol, 3-methyl-1,5-pentanediol, 1,1-dimethyl-1,5-pentanediol, 1,6-hexanediol, 2-ethyl-3-methyl-1,5-hexanediol, 2-ethyl-3-ethyl-1,5-hexanediol, 1,7-heptanediol, 2-ethyl-3-methyl-1,5-heptanediol, 2-ethyl-3-ethyl-1,6-heptanediol, 1,8-octanediol, 1,9-nonanediol, 1,10-decanediol, a derivative thereof, or any combination thereof.

The dicarboxylic acid may comprise an aromatic dicarboxylic acid, an aliphatic dicarboxylic acid, an alicyclic dicarboxylic acid, or an ester thereof.

For example, the dicarboxylic acid may be terephthalic acid, dimethylterephthalic acid, isophthalic acid, naphthalene dicarboxylic acid, orthophthalic acid, adipic acid, azelaic acid, sebacic acid, decanedicarboxylic acid, an ester thereof, or a combination thereof. Specifically, the dicarboxylic acid may comprise at least one selected from the group consisting of terephthalic acid, dimethyl terephthalate, naphthalene dicarboxylic acid, and orthophthalic acid.

According to an embodiment, the copolymerized polyester-based resin may be one in which two or more diols and an aromatic dicarboxylic acid are polymerized. According to another embodiment, the copolymerized polyester-based resin may be one in which three or more diols and an aromatic dicarboxylic acid are polymerized. According to still another embodiment, the copolymerized polyester-based resin may be one in which a diol comprising ethylene glycol and one or more comonomers and an aromatic dicarboxylic acid are polymerized. According to still another embodiment, the copolymerized polyester-based resin may be one in which a diol comprising ethylene glycol and two or more comonomers and an aromatic dicarboxylic acid are polymerized.

The diol may comprise the comonomer in an amount of 10% by mole or more based on the total number of moles of the diol. For example, the diol may comprise the comonomer in an amount of 10% by mole to 50% by mole, 10% by mole to 40% by mole, 15% by mole to 37% by mole, or 17% by mole to 35% by mole, based on the total number of moles of the diol. The diol may comprise, as a comonomer, the diols exemplified above except for ethylene glycol.

For example, the diol may comprise, as a comonomer, diethylene glycol, cyclohexanedimethanol (1,4-cyclohexanedimethanol), 1,3-propanediol, 1,2-octanediol, 1,3-octanediol, 2,3-butanediol, 1,3-butanediol, 1,4-butanediol, 1,5-pentanediol, neopentyl glycol, 2-butyl-2-ethyl-1,3-propanediol, 2,2-diethyl-1,5-pentanediol, 2,4-diethyl-1,5-pentanediol, 3-methyl-1,5-pentanediol, 1,1-dimethyl-1,5-pentanediol, or a combination thereof. Specifically, the comonomer may comprise at least one selected from the group consisting of neopentyl glycol, cyclohexanedimethanol, and diethylene glycol.

According to an embodiment, the diol comprises ethylene glycol, and it may comprise at least one comonomer selected from the group consisting of neopentyl glycol and diethylene glycol in an amount of 10% by mole or more based on the total moles of the diol. In such a case, it may be more advantageous for achieving the desired effect.

Specifically, the diol may comprise diethylene glycol as a comonomer. The diol may comprise diethylene glycol in an amount of 2.5% by mole to 10.0% by mole based on the total number of moles of the diol.

For example, the diol may comprise diethylene glycol in an amount of 2.5% by mole to 8.0% by mole, 2.5% by mole to 7.0% by mole, 2.5% by mole to 5.0% by mole, 2.5% by mole to less than 5.0% by mole, 2.5% by mole to 4.9% by mole, 2.5% by mole to 4.8% by mole, 3.0% by mole to 6.0% by mole, 3.5% by mole to 7.0% by mole, 3.5% by mole to 6.0% by mole, 3.5% by mole to 5.0% by mole, 3.0% by mole to 4.9% by mole, 3.3% by mole to 4.9% by mole, 3.4% by mole to 4.9% by mole, 3.4% by mole to 4.8% by mole, 4.0% by mole to 5.5% by mole, or 4.0% by mole to 5.0% by mole, based on the total number of moles of the diol.

When the content of diethylene glycol satisfies the above range, the shrinkage stress of the heat-shrinkable film can be lowered to a desired level, and it can be more advantageous for achieving the desired effect. If the content of diethylene glycol is less than the above range, the shrinkage stress increases, and the shrinkage initiation time is delayed, causing uneven shrinkage, which may lead to poor shrinkage or distortion of a plastic container.

The diethylene glycol may be naturally generated during the copolymerization process, or it may be added separately within a range that satisfies the above range to be contained in the copolymerized polyester-based resin. Alternatively, the diethylene glycol may be naturally generated during the copolymerization process, and it may be added separately within a range that satisfies the above range to be contained in the copolymerized polyester-based resin.

When the diethylene glycol is naturally generated during the copolymerization process, it may be contained within 3% by mole, within 2.5% by mole, or within 2% by mole.

In addition, the diol may comprise, as a comonomer, at least one of neopentyl glycol and cyclohexanedimethanol. The content of neopentyl glycol and/or cyclohexanedimethanol in the diol may be 1% by mole to 50% by mole, for example, 5% by mole to 40% by mole, 5% by mole to 30% by mole, 10% by mole to 40% by mole, 12% by mole to 30% by mole, 12% by mole to 28% by mole, or 12% by mole to 20% by mole.

Specifically, the diol may comprise, as a comonomer, at least one selected from neopentyl glycol and cyclohexanedimethanol; and diethylene glycol.

The diol may comprise neopentyl glycol, as a comonomer, in an amount of 5% by mole to 35% by mole, 8% by mole to 35% by mole, 10% by mole to 30% by mole, 12% by mole to 30% by mole, 15% by mole to 30% by mole, 12% by mole to 28% by mole, 12% by mole to 26% by mole, or 13% by mole to 26% by mole.

When the diol comprises neopentyl glycol, as a comonomer, in the above amount, the heat shrinkage rate in the transverse direction (TD) or in the longitudinal direction (MD) is readily adjusted when the heat-shrinkable film is thermally shrunk, so that it is possible to more effectively prevent wrinkles or deformation when the film is applied to a container.

In addition, the heat-shrinkable film may comprise both diethylene glycol and neopentyl glycol as a comonomer.

Specifically, the comonomer comprises neopentyl glycol and diethylene glycol, and the molar ratio of neopentyl glycol and diethylene glycol may be 1:0.10 to 0.40. Specifically, the molar ratio of neopentyl glycol and diethylene glycol may be 1:0.15 to 0.35, 1:0.15 to 0.32, 1:0.15 to 0.30, or 1:0.18 to 0.30.

According to an embodiment, the diol may comprise, as a comonomer, neopentyl glycol in an amount of 5% by mole to 35% by mole and diethylene glycol in an amount of 1% by mole to 15% by mole. Specifically, the diol may comprise, as a comonomer, neopentyl glycol in an amount of 10% by mole to 30% by mole and diethylene glycol in an amount of 2% by mole to 10% by mole. When the diol comprises a comonomer of the above components in the above amounts, it may be advantageous for achieving the desired effect.

Meanwhile, the dicarboxylic acid may comprise terephthalic acid or dimethyl terephthalate in an amount of 80% by mole or more, 90% by mole or more, or 95% by mole or more, based on the total number of moles of the dicarboxylic acid. In addition, the dicarboxylic acid may comprise almost no isophthalic acid. For example, the content of isophthalic acid in the dicarboxylic acid may be 5% by mole or less, 3% by mole or less, or 1% by mole or less.

Specifically, the diol may comprise, as a comonomer, at least one selected from the group consisting of neopentyl glycol, cyclohexanedimethanol, diethylene glycol, and a combination thereof in an amount of 10% by mole to 40% by mole, and the aromatic dicarboxylic acid may comprise isophthalic acid in the aromatic dicarboxylic acid in an amount of 10% by mole or less.

In addition, the diol may comprise recycled ethylene glycol, recycled diethylene glycol, or/and recycled neopentyl glycol, and the dicarboxylic acid may comprise recycled terephthalic acid.

In addition, the copolymerized polyester-based resin may be a glycol-modified polyethylene terephthalate (PETG).

The copolymerized polyester-based resin may further comprise an alcohol other than the diol, for example, a monohydric alcohol. Specifically, the monohydric alcohol may be methanol, ethanol, isopropanol, allyl alcohol, or benzyl alcohol. The copolymerized polyester-based resin may comprise the monohydric alcohol in an amount of 10 parts by weight to 40 parts by weight or 15 parts by weight to 30 parts by weight based on 100 parts by weight of the diol.

In addition, the copolymerized polyester-based resin may comprise at least one selected from the group consisting of a virgin copolymerized polyester-based resin and a recycled copolymerized polyester-based resin.

When the copolymerized polyester-based resin comprises the recycled copolymerized polyester-based resin, the dicarboxylic acid may comprise isophthalic acid, in addition to terephthalic acid, in an amount of 0% by mole to 3% by mole, 1% by mole to 10% by mole, 1% by mole to 5% by mole, 1% by mole to 4% by mole, or 2% by mole to 5% by mole, and the diol may comprise neopentyl glycol as a comonomer in an amount of 0 to 25% by mole, 0 to 20% by mole, 1 to 17% by mole, 1 to 15% by mole, 2 to 13% by mole, or 2 to 10% by mole.

In addition, the copolymerized polyester-based resin may comprise a first copolymerized polyester-based resin and a second copolymerized polyester-based resin having a different composition (e.g., different diol composition) from that of the first copolymerized polyester-based resin.

The copolymerized polyester-based resin may have a weight average molecular weight (Mw) of 20,000 to 100,000 g/mole, 35,000 to 70,000 g/mole, 40.000 to 60,000 g/mole, or 45,000 to 60,000 g/mole. The weight average molecular weight (Mw) may be measured by gel permeation chromatography (GPC).

In addition, the copolymerized polyester-based resin may have an intrinsic viscosity of 0.4 dl/g to 1.2 dl/g, 0.5 dl/g to 1.0 dl/g, 0.55 dl/g to 0.95 dl/g, or 0.6 dl/g to 0.85 dl/g, when measured according to ASTM D2857. When the intrinsic viscosity of the copolymerized polyester-based resin is within the above range, it may be more advantageous for achieving the desired effect.

### Polybutylene Terephthalate-Based Resin

According to an embodiment, the mixed resin contained in the heat-shrinkable film comprises a polybutylene terephthalate (PBT)-based resin.

The polybutylene terephthalate-based resin may comprise a polybutylene terephthalate obtained by directly esterifying or transesterifying 1,4-butanediol and terephthalic acid or dimethyl terephthalate, followed by polycondensation thereof.

In addition, the polybutylene terephthalate-based resin may comprise a copolymer of polybutylene terephthalate with a compound such as polytetramethylene glycol (PTMG), polyethylene glycol (PEG), polypropylene glycol, aliphatic polyester, and aliphatic polyamide, or a modified polybutylene terephthalate in which the polybutylene terephthalate is mixed with the above compound.

According to an embodiment, it may be very important to control the content of the polybutylene terephthalate-based resin to achieve the desired crystallinity, thickness deviation, and shrinkage characteristics.

In general, when a polybutylene terephthalate-based resin is used, crystallization takes place quickly, which may lower the adhesion by a solvent in gravure printing, UV curing printing, variable sleeve offset printing (VSOP), or the like, to adversely affect a heat shrinkage process and a seaming process, and thickness deviation may also increase. Thus, as the content of the polybutylene terephthalate-based resin is controlled, appropriate crystallization and thermal properties can be induced, and, in particular, the desired crystallization temperature (Tc), glass transition temperature (Tg), and melting temperature (Tm) can be achieved. It may be advantageous for achieving the desired effect.

The polybutylene terephthalate-based resin may be employed in an amount of 0.5% by weight to 50% by weight based on the total weight of the mixed resin. Specifically, the content of the polybutylene terephthalate-based resin may be 0.5% by weight to 40% by weight, 0.5% by weight to 35% by weight, 0.5% by weight to 34% by weight, 0.5% by weight to 30% by weight, 0.5% by weight to 25% by weight, 0.5% by weight to 20% by weight, 1% by weight to 40% by weight, 1% by weight to 35% by weight, 1% by weight to 34% by weight, 1% by weight to 30% by weight, 1% by weight to 25% by weight, 1% by weight to 20% by weight, 3% by weight to 40% by weight, 3% by weight to 35% by weight, 3% by weight to 34% by weight, 3% by weight to 30% by weight, 3% by weight to 25% by weight, 3% by weight to 20% by weight, 5% by weight to 40% by weight, 5% by weight to 35% by weight, 5% by weight to 34% by weight, 5% by weight to 30% by weight, 5% by weight to 25% by weight, 5% by weight to 20% by weight, 3% by weight to 10% by weight, 3% by weight to 8% by weight, or 3% by weight to 6% by weight, based on the total weight of the mixed resin.

When the polybutylene terephthalate-based resin satisfies the above content range, appropriate crystallinity and thickness deviation can be obtained, and the optimal development time of the initial shrinkage stress and/or maximum shrinkage stress can be achieved.

Owing to the polybutylene terephthalate-based resin, the heat-shrinkable film may comprise butanediol in an amount of 1% by weight to 50% by weight, 1% by weight to 30% by weight, 1% by weight to 20% by weight, 5% by weight to 50% by weight, 5% by weight to 30% by weight, or 5% by weight to 20% by weight, based on the total weight of the diol contained in the heat-shrinkable film.

The polybutylene terephthalate-based resin may have a weight average molecular weight (Mw) of 10,000 to 500,000 g/mole, 12,000 to 300,000 g/mole, 15,000 to 100,000 g/mole, 15,000 to 80,000 g/mole, 20,000 to 70,000 g/mole, or 20,000 to 60,000 g/mole. The weight average molecular weight (Mw) may be measured by gel permeation chromatography (GPC).

In addition, the polybutylene terephthalate-based resin may have an intrinsic viscosity of 0.5 dl/g to 2.0 dl/g, 0.6 dl/g to 1.5 dl/g, 0.6 dl/g to 1.3 dl/g, or 0.8 dl/g to 1.2 dl/g, when measured according to ASTM D2857. When the intrinsic viscosity of the polybutylene terephthalate-based resin is within the above range, it may be more advantageous for achieving the desired effect.

### Process for Preparing a Heat-Shrinkable Film

An embodiment provides a process for preparing the heat-shrinkable film.

The process for preparing the heat-shrinkable film may comprise preparing a copolymerized polyester-based resin in which a diol and a dicarboxylic acid are copolymerized; mixing the copolymerized polyester-based resin and a polybutylene terephthalate-based resin to prepare a mixed resin; extruding the mixed resin to prepare an unstretched sheet; and stretching and heat-setting the unstretched sheet to prepare a heat-shrinkable film.

Here, the composition and process conditions may be variously adjusted such that a heat-shrinkable film finally produced by the above process satisfies the characteristics (shrinkage characteristics and the like) as described above.

Specifically, in order for a final heat-shrinkable film to satisfy the characteristics as discussed above, the composition of the copolymerized polyester-based resin and the composition of the polybutylene terephthalate-based resin are adjusted, the contents and physical properties of the respective resins are adjusted, the extrusion and casting temperatures of the copolymerized polyester-based resin are adjusted, the preheating temperature, the stretching ratio in each direction, the stretching temperature, the stretching speed, and the like at the time of stretching are adjusted, or thermal treatment and relaxation are carried out after stretching while the thermal treatment temperature and relaxation rate are adjusted.

Hereinafter, each step will be described in more detail.

The process for preparing the heat-shrinkable film (S100) comprises preparing a copolymerized polyester-based resin in which a diol and a dicarboxylic acid are copolymerized (S110).

The copolymerized polyester-based resin may be prepared through a conventional transesterification reaction and polycondensation reaction. In such an event, the components and contents of the diol and dicarboxylic acid used are as exemplified above.

At least one catalyst selected from manganese acetate, calcium acetate, and zinc acetate may be used as a catalyst for the transesterification reaction. The content of the catalyst may be 0.02 part by weight to 0.2 part by weight, 0.02 part by weight to 0.1 part by weight, or 0.05 part by weight to 0.1 part by weight, relative to 100 parts by weight of the dicarboxylic acid.

In addition, upon completion of the transesterification reaction, at least one additive selected from the group consisting of silica, potassium, and magnesium; a stabilizer such as trimethyl phosphate; a polymerization catalyst such as antimony trioxide and tetrabutylene titanate; and the like may be selectively added.

The process for preparing the heat-shrinkable film (S100) comprises mixing the copolymerized polyester-based resin and a polybutylene terephthalate-based resin to prepare a mixed resin (S120).

The polybutylene terephthalate-based resin is as described above.

The mixing weight ratio of the copolymerized polyester-based resin and the polybutylene terephthalate-based resin is as described above.

The process for preparing the heat-shrinkable film (S100) comprises extruding the mixed resin to prepare an unstretched sheet (S130).

Specifically, the copolymerized polyester-based resin may be melted at a temperature of 260° C. to 300° C. or 270° C. to 290° C. and then extruded and cast to obtain an unstretched sheet. The process for preparing the heat-shrinkable film (S100) comprises stretching and heat-setting the unstretched sheet to prepare a heat-shrinkable film (S140).

It may further comprise preheating the unstretched sheet at 70° C. to 150° C. before the stretching.

Specifically, the unstretched sheet may be preheated at 70° C. to 130° C., 70° C. to 110° C., 80° C. to 110° C., 90° C. to 110° C., 95° C. to 110° C., or 95° C. to 105° C., for about 0.01 minute to 10 minutes, 0.05 minute to 5 minutes, 0.05 minute to 3 minutes, 0.05 minute to 1 minute, 0.05 minute to 0.5 minute, or 0.05 minute to 0.3 minute.

In addition, the unstretched sheet may be conveyed at a speed of 10 m/minute to 110 m/minute or 30 m/minute to 80 m/minute to pass through a roll and then preheated.

The stretching may be carried out at a temperature lower than the preheating temperature by 5° C. or more.

Specifically, the stretching may be carried out at a temperature lower than the preheating temperature by 8° C. or more, 10° C. or more, or 12° C. or more.

For example, the stretching may be carried out at 70° C. to 105° C., 75° C. to 100° C., or 75° C. to 90° C., in a first direction by 3 times to 5 times. Specifically, the stretching may be carried out at a stretching temperature of 60° C. to 90° C., 70° C. to 90° C., or 75° C. to 90° C., in a first direction by 3.0 times to 6.0 times, 3.5 times to 5.0 times, 3.5 times to 4.5 times, or 3.5 times to 4.2 times, but it is not limited thereto. The stretching may be further carried out in a second direction perpendicular to the first direction. For example, it may be carried out in a second direction at a stretching ratio of 1.1 times to 2 times or 1.1 times to 1.5 times, as needed.

For example, when the stretching is biaxial stretching, the stretching may be carried out in the longitudinal direction (MD) at a stretching ratio of 1.1 times to 2 times or 1.1 times to 1.5 times, and then in the transverse direction (TD) at a stretching ratio of 3.5 times to 5 times, 3.5 times to 4.8 times, or 3.8 times to 4.6 times.

After the stretching, the film may be heat-set. For example, the heat-setting may be carried out at 60° C. to 95° C. for 0.01 minute to 1 minute. For example, the heat-setting temperature may be 65° C. to 95° C., 65° C. to 90° C., 65° C. to 85° C., or 65° C. to 80° C., and the heat-setting time may be 0.05 minute to 0.5 minute or 0.08 minute to 0.2 minute. But they are not limited thereto.

Specifically, the difference between the preheating temperature and the heat-setting temperature may be 10° C. to 40° C., more specifically, 13° C. to 35° C., 11° C. to 34° C., 15° C. to 34° C., 10° C. to 30° C., 20° C. to 30° C., or 25° C. to 35° C. When the preheating temperature, the heat-setting temperature, and their difference each satisfy the above range, it may be more advantageous for achieving the desired effect.

### Effects and Uses

The heat-shrinkable film according to an embodiment comprises a mixed resin having a specific composition, wherein the development time of the initial shrinkage stress and/or that of the maximum shrinkage stress are controlled. As a result, it is possible to achieve a rapid shrinkage initiation time, thereby reducing the amount of heat required for shrinkage in the process, resulting in improvements in process efficiency, and to achieve excellent recyclability and uniform shrinkage at the same time, resulting in energy saving and excellent environmentally friendly properties and quality.

In addition, an article comprising the heat-shrinkable film may be a film (or sheet) or a component used in the field of automobiles, electricity, and electronics. In addition, the article may comprise, for example, labels or cap seals for various containers such as plastics, or packaging supplies.

Specifically, the heat-shrinkable film can be advantageously applied as a heat-shrinkable label or packaging material to containers of various products including beverages and food. For example, the heat-shrinkable label or packaging material comprises the heat-shrinkable film, and it may further comprise a printing layer, a dye, an adhesive, or the like.

### MODE FOR THE INVENTION

Hereinafter, the present invention will be described in more detail with reference to the following examples. However, these examples are set forth to illustrate the present embodiments, and the scope of the embodiments is not limited thereto.

### EXAMPLE

### Preparation of a Copolymerized Polyester-Based Resin

### Preparation Example 1-1

An autoclave (first reactor) equipped with a stirrer and a distillation column was charged with 100% by mole of terephthalic acid (TPA) as a dicarboxylic acid and 78% by mole of ethylene glycol (EG), 17% by mole of neopentyl glycol (NPG), and 5% by mole of diethylene glycol (DEG), as a diol, based on the total number of moles of the diol. 0.07 part by weight of manganese acetate as a transesterification catalyst was added relative to 100 parts by weight of the dicarboxylic acid, followed by heating the mixture to 220° C. and the removal of methanol as a byproduct to carry out the reaction.

Upon completion of the transesterification reaction, 0.07 part by weight of silica having an average particle diameter of 0.28 μm was added relative to 100 parts by weight of the dicarboxylic acid, and 0.4 part by weight of trimethyl phosphate as a stabilizer was added thereto. After 5 minutes, 0.035 part by weight of antimony trioxide and 0.005 part by weight of tetrabutylene titanate were added as a polymerization catalyst, followed by stirring for 10 minutes. Thereafter, the reaction mixture was transferred to a second reactor equipped with a vacuum apparatus. The pressure was gradually reduced while the temperature was raised to 285° C., and the polymerization was carried out for 210 minutes to thereby prepare a copolymerized polyester-based resin (intrinsic viscosity (IV): 0.67 dl/g).

### Preparation Example 1-2

An autoclave (first reactor) equipped with a stirrer and a distillation column was charged with 100% by mole of terephthalic acid (TPA) as a dicarboxylic acid and 65% by mole of ethylene glycol (EG), 30% by mole of neopentyl glycol (NPG), and 5% by mole of diethylene glycol (DEG), as a diol, based on the total number of moles of the diol. 0.07 part by weight of manganese acetate as a transesterification catalyst was added relative to 100 parts by weight of the dicarboxylic acid, followed by heating the mixture to 220° C. and the removal of methanol as a byproduct to carry out the reaction.

Upon completion of the transesterification reaction, 0.07 part by weight of silica having an average particle diameter of 0.28 μm was added relative to 100 parts by weight of the dicarboxylic acid, and 0.4 part by weight of trimethyl phosphate as a stabilizer was added thereto. After 5 minutes, 0.035 part by weight of antimony trioxide and 0.005 part by weight of tetrabutylene titanate were added as a polymerization catalyst, followed by stirring for 10 minutes. Thereafter, the reaction mixture was transferred to a second reactor equipped with a vacuum apparatus. The pressure was gradually reduced while the temperature was raised to 285° C., and the polymerization was carried out for 210 minutes to thereby prepare a copolymerized polyester-based resin (intrinsic viscosity (IV): 0.7 dl/g).

### Preparation Example 1-3

An autoclave (first reactor) equipped with a stirrer and a distillation column was charged with 100% by mole of terephthalic acid (TPA) as a dicarboxylic acid and 70% by mole of ethylene glycol (EG), 20% by mole of neopentyl glycol (NPG), and 10% by mole of diethylene glycol (DEG), as a diol, based on the total number of moles of the diol. 0.07 part by weight of manganese acetate as a transesterification catalyst was added relative to 100 parts by weight of the dicarboxylic acid, followed by heating the mixture to 220° C. and the removal of methanol as a byproduct to carry out the reaction.

Upon completion of the transesterification reaction, 0.07 part by weight of silica having an average particle diameter of 0.28 μm was added relative to 100 parts by weight of the dicarboxylic acid, and 0.4 part by weight of trimethyl phosphate as a stabilizer was added thereto. After 5 minutes, 0.035 part by weight of antimony trioxide and 0.005 part by weight of tetrabutylene titanate were added as a polymerization catalyst, followed by stirring for 10 minutes. Thereafter, the reaction mixture was transferred to a second reactor equipped with a vacuum apparatus. The pressure was gradually reduced while the temperature was raised to 285° C., and the polymerization was carried out for 210 minutes to thereby prepare a copolymerized polyester-based resin (intrinsic viscosity (IV): 0.78 dl/g).

### Preparation of a Heat-Shrinkable Film

### Example 1

95 parts by weight of the copolymerized polyester-based resin prepared in Preparation Example 1-1 was mixed with 5 parts by weight of polybutylene terephthalate (PBT) resin (KH2095, Kanghui New Material Technology, intrinsic viscosity (IV): 0.88 dl/g) to prepare a mixed resin.

The mixed resin was extruded through a T-die at 280° C. and then cooled to thereby prepare an unstretched sheet.

Thereafter, the unstretched sheet was passed through a roll while it was conveyed at a speed of 55 m/minute to thereby adjust the thickness thereof. Subsequently, the unstretched sheet was preheated at about 100° C. for about 0.1 minute and stretched 4.0 times in the transverse direction (TD) at about 85° C. Thereafter, the stretched sheet was heat-set at about 70° C. for about 0.1 minute to prepare a heat-shrinkable film having a thickness of about 45 μm.

### Examples 2 to 8 and Comparative Examples 1 to 3

A heat-shrinkable film was prepared in the same manner as in Example 1, except that the type and amount of the copolymerized polyester-based resin, the amount of the polybutylene terephthalate (PBT) resin, and the conditions of the film preparation process in Example 1 were changed as shown in Table 1 below.

The composition of the mixed resin and the conditions of the film preparation process in Examples 1 to 8 and Comparative Examples 1 to 3 are shown in Table 1. The final components of the heat-shrinkable film (for a diol, it is based on the total number of moles of diols) are shown in Table 2 below.

TABLE 1

| | Resin (% by weight) | | | | Film preparation process | | | |
|---|---|---|---|---|---|---|---|---|
| | Copolymerized polyester-based resin | | | | | | | Heat |
| | Preparation | Preparation | Preparation | | Stretching | Preheating | Stretching | setting |
| | Example | Example | Example | | ratio | temp. | temp. | temp. |
| | 1-1 | 1-2 | 1-3 | PBT | (TD) | (° C.) | (° C.) | (° C.) |
| Ex. 1 | 95 | 0 | 0 | 5 | 4.0 | 100 | 85 | 70 |
| Ex. 2 | 80 | 0 | 0 | 20 | 4.0 | 90 | 80 | 80 |
| Ex. 3 | 20 | 75 | 0 | 5 | 4.5 | 90 | 78 | 70 |
| Ex. 4 | 45 | 45 | 0 | 10 | 4.5 | 85 | 80 | 80 |
| Ex. 5 | 65 | 0 | 0 | 35 | 4.0 | 140 | 130 | 70 |
| Ex. 6 | 50 | 0 | 0 | 50 | 4.0 | 90 | 85 | 80 |
| Ex. 7 | 90 | 0 | 0 | 10 | 4 | 100 | 85 | 78 |
| Ex. 8 | 20 | 0 | 70 | 10 | 4.5 | 90 | 80 | 80 |
| C. Ex. 1 | 100 | 0 | 0 | 0 | 4.0 | 120 | 78 | 78 |
| C. Ex. 2 | 70 | 30 | 0 | 0 | 4.5 | 120 | 80 | 80 |
| C. Ex. 3 | 99 | 0 | 0 | 1 | 4.0 | 140 | 130 | 96 |

TABLE 2

| | Heat-shrinkable film | | | |
|---|---|---|---|---|
| | EG (% | NPG (% | DEG (% | BD (% |
| | by mole) | by mole) | by mole) | by mole) |
| Ex. 1 | 74 | 16.2 | 4.8 | 5.0 |
| Ex. 2 | 62.4 | 13.6 | 4.0 | 20.0 |
| Ex. 3 | 64.3 | 25.9 | 4.8 | 5.0 |
| Ex. 4 | 64.3 | 21.2 | 4.5 | 10.0 |
| Ex. 5 | 50.6 | 11.1 | 3.3 | 35.0 |
| Ex. 6 | 39 | 8.5 | 2.5 | 50.0 |
| Ex. 7 | 70.2 | 15.3 | 4.5 | 10 |
| Ex. 8 | 64.6 | 17.4 | 8 | 10 |
| C. Ex. 1 | 78 | 17.0 | 5.0 | 0.0 |
| C. Ex. 2 | 74.1 | 20.9 | 5.0 | 0.0 |
| C. Ex. 3 | 77.2 | 16.8 | 5.0 | 1.0 |

* EG: ethylene glycol
* NPG: neopentyl glycol
* DEG: diethylene glycol
* BD: 1,4-butanediol

### EVALUATION EXAMPLE

### Evaluation Example 1: Measurement of the Development Time of Shrinkage Stress and Shrinkage Stress

FIG. 2 shows a method for measuring the development time of shrinkage stress and the shrinkage stress in a heat-shrinkable film.

Referring to FIG. 2, the heat-shrinkable films (100) of Examples 1 to 8 and Comparative Examples 1 to 3 were each cut to 120 mm in the transverse direction (TD) to be measured and 15 mm in the longitudinal direction (MD) perpendicular thereto. Each heat-shrinkable film specimen with a width of 15 mm, a length of 110 mm, and a thickness of 45 μm, excluding 5 mm at each end (X) in the transverse direction (TD), was mounted on a stress tester (2), specifically, a shrinkage stress meter (CKPT-180S, CK Corporation) equipped with a load cell (BONGSHIN, OBUH-10; capacity: 10 kg). Here, both ends (X) of the heat-shrinkable film specimen were fixed to both jigs (21) of the stress tester (2) spaced apart by 100 mm (space between the jigs (21): 100 mm). The length of the heat-shrinkable film specimen is a value excluding both ends (X) (excluded from measurement) of 5 mm each in the transverse direction (TD), and the width thereof is a value cut in the longitudinal direction (MD).

Thereafter, the heat-shrinkable film specimen as mounted was immersed in hot water at 70° C. for 60 seconds to measure shrinkage stress. The initial shrinkage stress, maximum shrinkage stress, and development time of maximum shrinkage stress were evaluated. The results are shown in Table 3.

### Evaluation Example 2: Differential Scanning Calorimetry (DSC)

The heat-shrinkable films prepared in Examples 1 to 8 and Comparative Examples 1 to 3 were each analyzed by differential scanning calorimetry (DSC) to determine glass transition temperature (Tg), melting temperature (Tm) and crystallization temperature (Tc). The results are shown in Table 3 below.

The DSC analysis of the heat-shrinkable film was carried out as follows.

About 4 mg of a sample of each heat-shrinkable film was scanned in a differential scanning calorimeter (DSC) mode at a temperature elevation rate of 10° C./minute using a differential scanning calorimeter (Q2000, manufacturer: TA Instruments).
(1) First heating measurement over the temperature range of 25° C. to 300° C. at a scan rate of 10° C./minute
(2) Maintaining isothermal at 300° C. for 10 minutes
(3) First cooling measurement over the temperature range of 300° C. to 25° C. at a scan rate of 10° C./minute
(4) Maintaining isothermal at 25° C. for 10 minutes
(5) Second heating measurement over the temperature range of 25° C. to 300° C. at a scan rate of 10° C./minute

In the heat flow curve obtained by scanning, the first exothermic temperature in the first heating measurement (step (1)) was the crystallization temperature (Tc), and the endothermic temperature measured after the crystallization temperature (Tc) was the melting temperature (Tm). In addition, the endothermic temperature measured during the second heating measurement (step (5)) after the first cooling measurement (step (3)) was the glass transition temperature (Tg).

### Evaluation Example 3: Clumping Ratio

The clumping ratio (CR, %) was measured according to the procedure for polyethylene terephthalate flake clumping evaluation (APR PET-S-08) of the U.S. Association of Plastic Recyclers (APR).

FIG. 3 shows a method of measuring the clumping of a polyethylene terephthalate (PET) container provided with a heat-shrinkable film.

Referring to FIG. 3, a product (1) in which a heat-shrinkable film was provided as a label (11a) in a polyethylene terephthalate (PET) container (20) was crushed in a crusher (6) and passed through a sieve (0.374″ sieve, not shown) having an average hole diameter of 9.5 mm to obtain mixed flakes composed of 97 g of first flakes (20a) obtained by crushing the polyethylene terephthalate (PET) and 3 g of second flakes (label flakes) (10a) obtained by crushing the heat-shrinkable film. In such an event, the heat-shrinkable film of each of Examples 1 to 8 and Comparative Examples 1 to 3 was used as the label (11a) (see FIGS. 1 and 3(a)).

Thereafter, the mixed flakes were placed on a cylinder having a diameter of 6 cm and a height of 8 cm, and a weight (7) of 2.5 kg was placed thereon to apply the 8.7 kPa load. Thereafter, the cylinder with the weight (7) thereon was thermally treated in a convection oven at 195° C. for 90 minutes and then cooled at room temperature (see FIG. 3(b)).

Thereafter, the cooled mixed flakes were passed through a second sieve (0.492″ sieve) with an average hole diameter (d) of 12.5 mm, and the aggregated flakes (30b) remaining on the second sieve (8) were collected (see FIG. 3(c)). The weight of the flakes was measured to calculate the clumping ratio (CR) represented by the following Equation 1.

$$Clumping ratio ( CR , \% ) = \frac{{C}_{195}}{{C}_{25}} \times 100 \qquad [ Equation 1 ]$$

In Equation 1, C₂₅ is the initial weight (g) of mixed flakes obtained by crushing a polyethylene terephthalate (PET) container provided with the heat-shrinkable film at 25° C., and C₁₉₅ is the weight (g) of aggregated flakes that had not been filtered through a 12.5-mm sieve when the mixed flakes obtained by crushing the polyethylene terephthalate (PET) container provided with the heat-shrinkable film were thermally treated at 195° C. for 90 minutes and then filtered.

### Evaluation Example 4: Heat Shrinkage Rate

FIG. 4 shows a method of measuring the heat shrinkage rate of a heat-shrinkable film. Referring to FIG. 4, the heat-shrinkable films prepared in Examples 1 to 8 and Comparative Examples 1 to 3 were each cut to 300 mm in the main shrinkage direction (transverse direction (TD)) and 15 mm in the direction perpendicular thereto (longitudinal direction (MD)). Here, 300 mm was the first dimension (x1) before shrinkage, and 15 mm was the second dimension (y) (see FIG. 4(a)).

Thereafter, the cut heat-shrinkable film (100) was immersed in a heated water bath for 10 seconds and then taken out. The first dimension (x2) after shrinkage was measured (see FIG. 4(b)). The heat shrinkage rate represented by the following Equation 2 was calculated.

$$Heat shrinkage rate ( T {S}_{100} , \% ) = \frac{x 1 - x 2}{x 1} \times 100 \qquad [ Equation 2 ]$$

In Equation 2, x1 is the initial length of a heat-shrinkable film specimen measured at 25° C., and x2 is the length of the heat-shrinkable film specimen, after shrinkage, measured after immersion in hot water at 100° C. for 10 seconds.

In addition, the heat-shrinkable film specimen was immersed in hot water at 70° C., 80° C., and 90° C., respectively, for 10 seconds. Then, the heat shrinkage rate for each temperature was calculated using the same method as above.

### Evaluation Example 5: Thickness Deviation (R)

FIG. 5 shows a method of measuring the thickness deviation (R) of a heat-shrinkable film.

Referring to FIG. 5, a roll of the heat-shrinkable film prepared in each of Examples 1 to 8 and Comparative Examples 1 to 3 was cut across the entire width of the film in the transverse direction (TD) (FIG. 5(a)). The thickness of the obtained heat-shrinkable film specimen having a width of 300 mm and a length of 200 mm was measured using a thickness gauge (MFC-101, Nikon). Here, the width was a value cut in the longitudinal direction (MD).

For the measurement of thickness, the thickness was measured at intervals of 2 cm in the transverse direction (TD) with the center (C) point in the longitudinal direction (MD) of the heat-shrinkable film specimen as an axis. In addition, the average thickness of the heat-shrinkable film and the thickness showing the maximum difference from the average thickness were obtained using the respective thicknesses measured. Then, the thickness deviation (R) represented by the following Equation 3 was calculated.

$$Thickness deviation ( R , μm ) = TA - TF \qquad [ Equation 3 ]$$

In Equation 3, TA and TF are values calculated using the thicknesses measured with a thickness gauge at intervals of 2 cm in the transverse direction (TD) with the center point in the longitudinal direction (MD) of the heat-shrinkable film specimen having a width of 300 mm and a length of 200 mm as an axis.

TA is the average thickness (μm) of the measured thicknesses, and TF is the thickness (μm) showing the maximum difference from the average thickness among the measured thicknesses.

The results obtained from the above Evaluation Examples are shown in Tables 3 and 4 below.

TABLE 3

| | Thickness | | | | | | | | | |
|---|---|---|---|---|---|---|---|---|---|---|
| | deviation | | | | | Clumping | | | | |
| | (R) | Tc | Tm | Tg | Tc − Tg | ratio | Heat shrinkage rate (TD) | | | |
| | (μm) | (° C.) | (° C.) | (° C.) | (° C.) | (CR, %) | 70° C. | 80° C. | 90° C. | 100° C. |
| Ex. 1 | 2 | 97 | 203.8 | 72.6 | 24.4 | 0.12 | 47 | 72 | 75 | 76 |
| Ex. 2 | 2 | 90.4 | 201/219 | 65.5 | 24.9 | 0.95 | 19 | 51 | 66 | 71 |
| Ex. 3 | 2 | 138.5 | 210/228 | 71.7 | 66.8 | 0.72 | 53 | 74 | 77 | 78 |
| Ex. 4 | 2 | 116.3 | 213/233 | 68.8 | 47.5 | 0.88 | 59 | 73 | 75 | 78 |
| Ex. 5 | 15 | 71.8 | 215 | 62.3 | 9.5 | 5.4 | 18 | 27 | 52 | 57 |
| Ex. 6 | 11 | 68.4 | 219 | 59.3 | 9.1 | 9.4 | 8 | 31 | 47 | 49 |
| Ex. 7 | 2 | 111 | 200/219 | 69.9 | 41.1 | 0.51 | 25 | 60 | 72 | 74 |
| Ex. 8 | 2 | 93.4 | 202.8 | 67.2 | 26.2 | 1 | 38 | 64 | 75 | 77 |
| C. Ex. 1 | 2 | 111.3 | 202.0 | 74.3 | 37 | 1.3 | 38 | 70 | 75 | 75 |
| C. Ex. 2 | 2 | 128.2 | 186.7 | 73.7 | 54.5 | 6.7 | 35 | 73 | 78 | 78 |
| C. Ex. 3 | 12 | 118.2 | 203.7 | 74.0 | 44.2 | 3.2 | 6 | 25 | 42 | 51 |

TABLE 4

| | Development | | Development | |
|---|---|---|---|---|
| | time of | Time for | time of | |
| | initial | the shrinkage | maximum | Maximum |
| | shrinkage | stress to | shrinkage | shrinkage |
| | stress | reach 0.5N | stress | stress |
| | (seconds) | (seconds) | (seconds) | (N) |
| Ex. 1 | 3.5 | 3.6 | 6.8 | 6.3 |
| Ex. 2 | 10 | 10 | 30 | 3.6 |
| Ex. 3 | 2.8 | 2.9 | 4.5 | 7.2 |
| Ex. 4 | 3 | 3.1 | 4.7 | 4.9 |
| Ex. 5 | 2.7 | 2.8 | 7.5 | 3.2 |
| Ex. 6 | 4.5 | 4.8 | 10.2 | 2.8 |
| Ex. 7 | 3.5 | 3.6 | 6 | 4.6 |
| Ex. 8 | 3 | 3.1 | 14.5 | 3.8 |
| C. Ex. 1 | 23 | 23.2 | 28 | 6.2 |
| C. Ex. 2 | 21 | 21.1 | 22.2 | 7.1 |
| C. Ex. 3 | — | — | — | — |

As can be seen from Tables 3 and 4 above, in the heat-shrinkable films of Examples 1 to 8, in which the development time of the initial shrinkage stress and that of the maximum shrinkage stress were controlled, it was possible to achieve a rapid shrinkage initiation time, thereby reducing the amount of heat required for shrinkage in the process, resulting in improvements in process efficiency, and to achieve excellent recyclability and uniform shrinkage at the same time.

Specifically, in the heat-shrinkable films of Examples 1 to 8, appropriate ranges of crystallization temperature (Tc), glass transition temperature (Tg), melting temperature (Tm), and the difference (Tc−Tg) between the crystallization temperature (Tc) and the glass transition temperature (Tg) were satisfied, thereby controlling crystallinity. Not only did they have a low thickness deviation during film formation, but the heat shrinkage rate measured at each temperature of 70° C., 80° C., 90° C., and 100° C. was also controlled to a specific range to shrink uniformly during the heat shrinkage process, whereby it could tightly adhere to the container without appearance defects such as distortion or curling after shrinkage, providing a uniform appearance. In addition, the polyethylene terephthalate (PET) container provided with the heat-shrinkable film as a label had a very low clumping ratio; thus, it is advantageous for the regeneration process at high temperatures for a long period of time, thereby enhancing recyclability.

In contrast, in the heat-shrinkable films of Comparative Examples 1 and 2, which did not contain a polybutylene terephthalate (PBT) resin, the development time of the initial shrinkage stress and that of the maximum shrinkage stress, and the maximum shrinkage stress were increased as compared with the heat-shrinkable films of Examples 1 to 8. The polyethylene terephthalate (PET) container provided with the heat-shrinkable film as a label had a significantly increased clumping ratio.

In addition, in the heat-shrinkable film of Comparative Examples 3, in which the initial shrinkage stress did not develop within 60 seconds although a polybutylene terephthalate (PBT) resin was employed (since the initiation (development) of shrinkage was very slow, making it difficult to measure the initiation time of shrinkage), the thickness deviation was increased significantly, the thermal properties and seaming properties of the heat-shrinkable film were poor, and the amount of heat required for shrinkage in the process was increased, thereby increasing energy consumption. Thus, it is difficult to be used in various products.

Accordingly, the heat-shrinkable film according to the embodiment comprises a mixed resin having a specific composition, wherein the development time of the initial shrinkage stress and that of the maximum shrinkage stress are controlled. As a result, it is possible to achieve a rapid shrinkage initiation time, thereby reducing the amount of heat required for shrinkage in the process, resulting in improvements in energy efficiency and to achieve excellent recyclability and uniform shrinkage at the same time; thus, it is possible to achieve energy saving and excellent environmental friendliness properties and quality.

### EXPLANATION OF REFERENCE NUMERALS

1: product (container) provided with a label
2: stress tester
6: crusher
7: weight
8: sieve
10a: second flakes
11: label before shrinkage 11a: label after shrinkage
20: product (container)
20a: first flakes
21: zig
22: load cell
30a: flakes that have passed through a sieve after thermal treatment
30b: flakes that have not passed through a sieve after thermal treatment, or aggregated
flakes
100: heat-shrinkable film before shrinkage
100a: heat-shrinkable film after shrinkage
A: axis
C: center
X: both ends (excluded from measurement)
d: hole diameter
x1: first dimension before shrinkage
x1: first dimension after shrinkage
y: second dimension
TD: transverse direction
MD: longitudinal direction
S_{M}: initial shrinkage stress
S_{MAX}: maximum shrinkage stress
S_{RES}: residual shrinkage stress

What is claimed is:

1. A heat-shrinkable film, which comprises a mixed resin, wherein the mixed resin comprises a copolymerized polyester-based resin in which a diol and a dicarboxylic acid are copolymerized; and a polybutylene terephthalate-based resin, and
when a specimen of the heat-shrinkable film having a width of 15 mm, a length of 110 mm, and a thickness of 45 μm is immersed in hot water at 70° C. for 60 seconds to measure shrinkage stress, the development time of the initial shrinkage stress is 20 seconds or shorter.

2. The heat-shrinkable film of claim 1, wherein when the heat-shrinkable film specimen is immersed in hot water at 70° C. for 60 seconds to measure shrinkage stress, the maximum shrinkage stress is 2.5 N to 10.0 N.

3. The heat-shrinkable film of claim 1, wherein the difference (Tc−Tg) between the crystallization temperature (Tc) and the glass transition temperature (Tg) of the heat-shrinkable film is 10° C. or more.

4. The heat-shrinkable film of claim 1, wherein the clumping ratio (CR) is 10% or less as represented by the following Equation 1:
$$Clumping ratio ( CR , \% ) = \frac{{C}_{195}}{{C}_{25}} \times 100 \qquad [ Equation 1 ]$$
in Equation 1, C₂₅ is the initial weight (g) of mixed flakes obtained by crushing a polyethylene terephthalate (PET) container provided with the heat-shrinkable film at 25° C., and C₁₉₅ is the weight (g) of aggregated flakes that have not been filtered through a 12.5-mm sieve when the mixed flakes obtained by crushing the polyethylene terephthalate (PET) container provided with the heat-shrinkable film are thermally treated at 195° C. for 90 minutes and then filtered.

5. The heat-shrinkable film of claim 1, wherein the heat-shrinkable film has a heat shrinkage rate of 45% or more as represented by the following Equation 2:
$$Heat shrinkage rate ( {TS}_{100} , \% ) = \frac{x 1 - x 2}{x 1} \times 100 \qquad [ Equation 2 ]$$
in Equation 2, x1 is the initial length of the heat-shrinkable film specimen measured at 25° C., and x2 is the length of the heat-shrinkable film specimen, after shrinkage, measured after immersion in hot water at 100° C. for 10 seconds.

6. The heat-shrinkable film of claim 1, wherein the thickness deviation (R) is 15 μm or less as represented by the following Equation 3:
$$Thickness deviation ( R , µm ) = TA - TF \qquad [ Equation 3 ]$$
in Equation 3, TA and TF are values calculated using the thicknesses measured with a thickness gauge at intervals of 2 cm in the transverse direction (TD) with the center point in the longitudinal direction (MD) of the heat-shrinkable film specimen having a width of 300 mm and a length of 200 mm as an axis,
TA is the average thickness (μm) of the heat-shrinkable film, and
TF is the thickness (μm) showing the maximum difference from the average thickness among the measured thicknesses.

7. The heat-shrinkable film of claim 1, wherein the polybutylene terephthalate-based resin is employed in an amount of 0.5% by weight to 50% by weight based on the total weight of the mixed resin.

8. The heat-shrinkable film of claim 1, wherein the diol comprises ethylene glycol, and it comprises at least one comonomer selected from the group consisting of neopentyl glycol and diethylene glycol in an amount of 10% by mole or more based on the total moles of the diol.

9. The heat-shrinkable film of claim 8, wherein the diol comprises diethylene glycol in an amount of 2.5% by mole to 10.0% by mole based on the total number of moles of the diol.

10. The heat-shrinkable film of claim 8, wherein the comonomer comprises neopentyl glycol and diethylene glycol, and the molar ratio of neopentyl glycol and diethylene glycol is 1:0.10 to 0.40.

11. The heat-shrinkable film of claim 1, wherein the copolymerized polyester-based resin is at least one selected from the group consisting of a virgin copolymerized polyester-based resin and a recycled copolymerized polyester-based resin.

12. A process for preparing the heat-shrinkable film of claim 1, which comprises:
preparing a copolymerized polyester-based resin in which a diol and a dicarboxylic acid are copolymerized;
mixing the copolymerized polyester-based resin and a polybutylene terephthalate-based resin to prepare a mixed resin;
extruding the mixed resin to prepare an unstretched sheet; and
stretching and heat-setting the unstretched sheet to prepare a heat-shrinkable film.

13. The process for preparing the heat-shrinkable film according to claim 12, which further comprises preheating the unstretched sheet at 70° C. to 150° C. before the stretching.

14. The process for preparing the heat-shrinkable film according to claim 13, wherein the stretching is carried out at a temperature lower than the preheating temperature by 5° C. or more.
